(19) United States
(12) Patent Application Publication
(10) Pub. No.: US 2006/0239489 A1
(43) Pub. Date: Oct. 26, 2006

(54) Noise damping headset with a throat microphone

(76) Inventor: Bo Franzén, Nybro (SE)

Correspondence Address: OSTROLENK FABER GERB & SOFFEN, 1180 AVENUE OF THE AMERICAS, NEW YORK, NY, 100368403, US

(21) Appl. No.: 10/570,679

(22) PCT Filed: Sep. 3, 2004
(86) PCT No.: PCT/SE04/01275

§ 371 Date: Apr. 18, 2006

(30) Foreign Application Priority Data
Sep. 4, 2003 (SE) 0302404-9

(51) Int. Cl. H04R 25/00

(52) U.S. Cl. 381/375

(57) ABSTRACT

The invention relates to a noise damping headset comprising at least one microphone and at least one ear phone intended to be connected via electrical conduits, preferably wires, to a transmitter and a receiver, preferably a mobile telephone, a communication radio or the like for communication between persons. The microphone consists of throat microphone for direct or indirect contact against the skin around a throat, the equipment mainly being sound tightening for sounds, coming from outside, from emerging into the throat microphone and the ear phone comprises a funnel-shape for inserting the same into the auditory canal of a person”s ear, the outer limiting surfaces of the funnel-shape being sound tightening against the walls of the auditory canal, the sound coming from outside being prevented from emerging into the auditory canal, whereby a communication between said persons can be held without being disturbed in a greater extent of the sound coming from outside.

The present invention relates to a noice damping headset intended to be connected via electrical conduits to a mobile telephone, a communication radio or the like for communication between persons, and said headset comprises a throat microphone, which is tight against sound coming from outside, and at least one ear phone, which tighten against the walls of the auditory canal, so that sounds comming from outside mainly are prevented to emerge into the auditory canal of an ear, so that a communication between said persons can be held without being disturbed by the sound coming from outside.

In connection to this kind of devices present on the market today noice damping “headsets,” are used in order to communicate with persons in a working place, between vehicles, such as tractors, cars, motor bikes, and so on via one or more communication radios or via mobile telephones. These headsets are made as receivers, which surround the outer ears of a person, in order to stop noice coming from outside. The receivers are made in a sound insulating material. Owing to this much noice coming from outside leaks into the auditory canal of the ear. The receivers are connected by a spring clamp extending over the head. A microphone is fixed to the receivers or the clamp via an arm, so that the microphone is located in the near of the mouth of the user during the use of the noice damping headset. Very much of the noice coming from outside emerges into the microphone and disturbes the communication. It is previously known to put in ear phones with a funnel-shape having wings for its fixing into the ear without using a clamp. If such structures are used one certainly receive a tightening of the sound coming from outside but the microphone leaks in too much of this sound, why this solution still does not function. One uses built in ear phones and microphone in helmets intended to be used at working places and said vehicles. Also here too much of the sound coming from outside leaks in. Between motorbikes no communication can be made over 50 to 70 km/hour, mostly depending on that the sound coming from outside leaks into the microphone. But also because of that the ear phones in the helmet are also leaking.

The object of the present invention is to solve the problems mentioned above by using ear phones and throat microphones which are mainly tight for sound coming from outisde.

Thanks to the invention a noice damping headset has now been provided, which comprises a microphone and ear phones, which are connected via electical conduits such as wires to a mobile telephone, a communication radio or the like for communication between persons, said microphone consisting of a throat microphone for contacting the skin around a throat, so that the structure maily is sound tightening sound coming from outside to emerge into the throat microphone. In providing the ear phone with a funnel-shape, which is inserted into the auditory canal of the ear, the outer limiting surfaces of the funnel-shape are connected with the walls of the auditory canal and are sound tightening in this way the sound coming from outside to emerge into the auditory canal and further into the inner ear. When both the throat microphone and the ear phones now are sound insulated from sound coming from outside a communication between the persons can be made without being disturbed in a greater extent of the sound coming from outside. During a preferred embodiment example of the invention, the funnel-shape is provided with at least one surrounding wing, which functions as a sound tightening joint or as a fastening element. In this case the ear phone is fixed in the auditory canal at the same time as the fastening element is sound tightening better against the walls of the auditory canal, so that sound coming from outside in a better way is kept outside the ear phone. In an alternative embodiment example of the invention the throat microphone is equipped so that the microphone itself is fixed in a cap and turned to a direction towards the skin around the throat and in that place cast in in surrounding silicone, so that the sound coming from outside has difficult to emerge through the surrounding silicone. In order to get a good contact of the throat microphone against the skin around the throat the throat microphone is fixed to a clamp, which is resilent so that the clamp can be biased around e.g. the neck of a person, throat or other part of the body, so that a better tightening at the tightening collar is provided. The throat microphone can of course be fixed against the skin by aid of a tape or by aid a connected rubber strip or a connected strip intended to be tied around any part of the body. The greatest advantages with the invention are that a noise damping headset has been created, which very much stops sound comming from outside to emerge into the auditory canal, so that a communication between persons can be performed without being disturbed in any greater extent also during high noise levels. Further the headset is very ligth and takes little place and is also cheep to manufacture. It can be used in ordinary protecting helmets and MC-helmets, which also gives a great economical saving. During a communication the person, which is talking and listening in the headset speaks with a very much lower loud level, so that persons in the nearhod are not disturbed.

The invention will be described in more detail below by aid of some preferred embodiment examples with reference to the drawings enclosed, in which

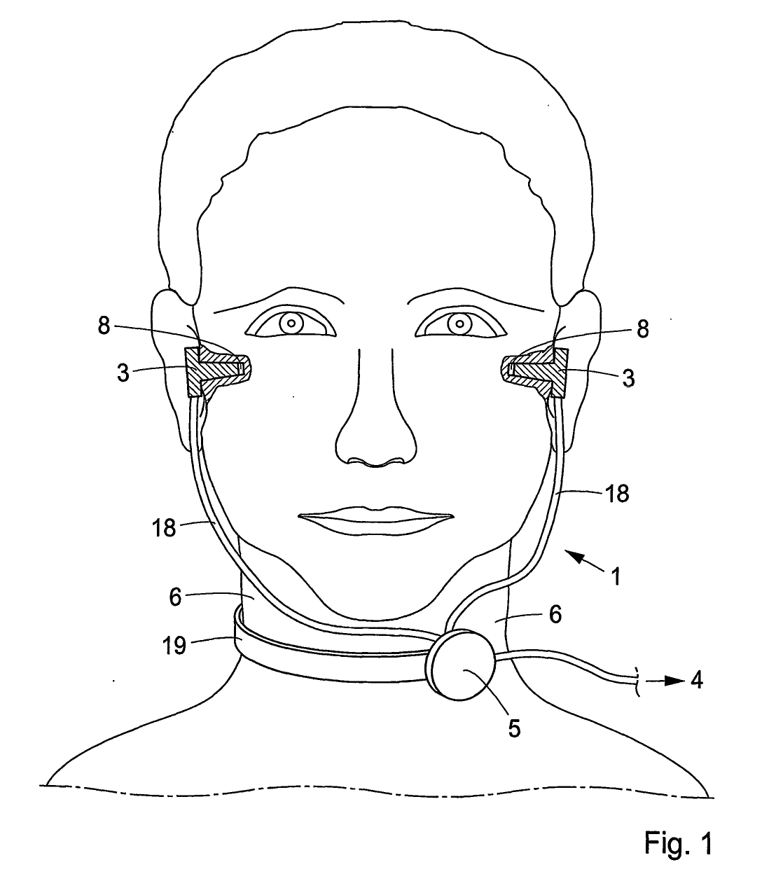

FIG. 1 illustrates a partly transluced perspective view of a head of a person using a headset,

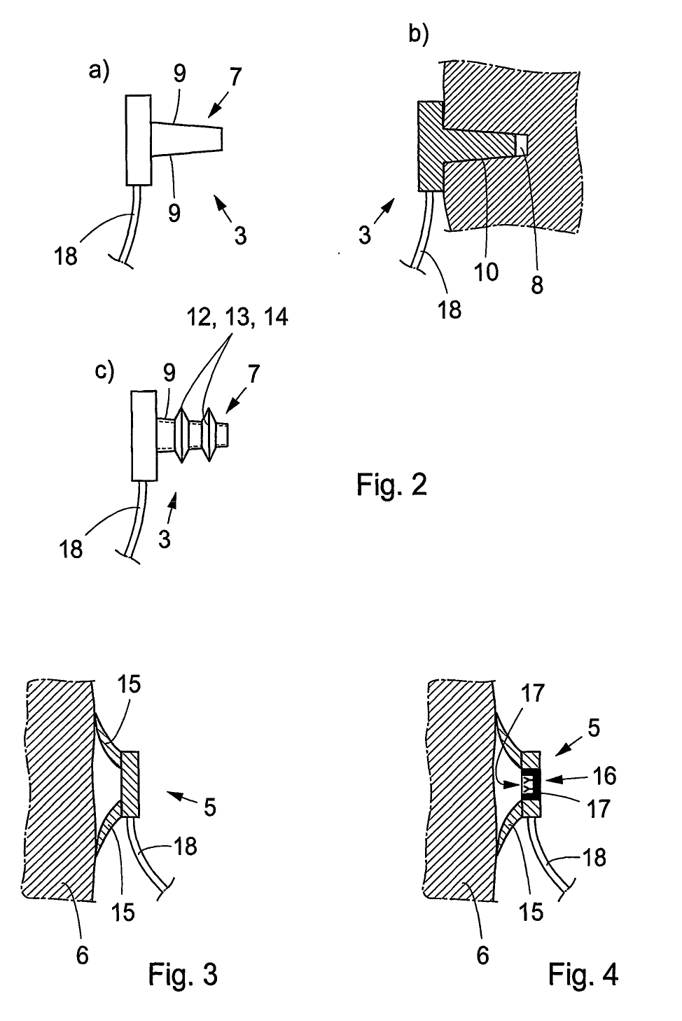

FIG. 2 illustrates in a part view a) an earphone having a funnel shape in a side view before said funnel shape is inserted into the auditory canal. The part view c) illustrates the funnel shape in a vertical section after having been inserted into the auditory canal. The part view c) illustrates an alternative embodiment example av said funnel shape in a side view before the same has been inserted into the auditory canal,

FIG. 3 illustrates a throat microphone in a vertical section and which is lying in contact with the skin around a throat and

FIG. 4 illustrates a throat microphone in a vertical section lying in contact with the skin around a throat having a directed microphone.

As can be seen from FIG. 1 a person is illustrated equipped with a noice damping headset 1 comprising two earphones 3, inserted into auditory canals 8, and they are fixed in a sound tightening way, so that sound 11 coming from outside does not emerge into the auditory canal 8 and a throat microphone lying in contact with the skin around the throat 6, which are connected via conduits 18 to a transmitter and a receiver 4. The throat microphone 5 is fixed to a clamp 19. The contact against the throat 6 sound-tightens from the sound 11 coming from outside to emerge into the throat microphone 5.

In FIG. 2 it is illustrated in a part view a) the ear phone 3 having a funnel shape 7 with outer limiting surfaces 9, which shall sound-tighten against the walls 10 of the auditory canal 8. In part view b) the ear phone 3 is illustrated when the same is inserted into the auditory canal 8. In part view c) the limiting surfaces 9 are completed with surrounding wings 12, which consist of a sound tightening joint 13 or of a fixing element 14.

In FIG. 3 a throat microphone 5 is illustrated having a tightening flange or collar 15 for better tightening against the skin around a throat 6.

In FIG. 4 the throat microphone 5 is illustrated as formed with a cap 16, in which a microphone 17 directed towards the skin around the throat 6 is cast in in the surrounding silicone 18.

1. A noise damping headset comprising at least one micro-phone and at least one ear phone intended to be connected via electrical conduits, preferably wires, to a transmitter and a receiver, preferably a mobile telephone, a communication radio or the like for communication between persons, wherein said headset is kept together by said wires and that said microphone consists of a throat microphone for direct or indirect contact against the skin around a throat, the equipment mainly being sound-tightening for sounds, coming from outside, from emerging into the throat microphone and that the ear phone comprises a funnel-shape for inserting the same into the auditory canal of a person's ear, the outer limiting surfaces of the funnel-shape being sound tightening against the walls of the auditory canal, whereby a communication between the persons can be held without being disturbed in a greater extent of the sound coming from outside.

2. A headset according to claim 1, wherein the funnel-shape is provided with at least one surrounding wing, which functions as a sound tightening joint and/or as a fastening element, the ear phone being fixed in the auditory canal and/or the fastening element being sound tightening better against the walls of the auditory canal, the sound coming from outside in a better way being kept outside the ear phone.

3. A headset according to claim 1, wherein the throat microphone, during its contact against the skin at the throat, comprises a tightening flange or collar for better contact against the skin around the throat, the sound coming from outside being better kept outside the throat microphone.

4. A headset according to claim 1, wherein the throat microphone comprises a cap, in which a microphone directed towards the skin around the throat is cast in surrounding silicone, the sound coming from outside being prevented to emerge through the surrounding silicone.

5. A headset according to claim 1, wherein the ear phone and/or the throat microphone are fixed in a clamp.

6. A headset according to claim 2, wherein the sound tightening joint and/or the fixing element is manufactured by a soft material preferably a rubber or rubberlike material.

7. A headset according to claim 3, wherein the tightening collar is manufactured by a soft material preferably a rubber or rubberlike material.

8. A headset according to claim 1, wherein the throat microphone is fixed in the clamp, which is resilient, whereby the throat microphone during its fixing around e.g. the neck of a person, throat or other part of the body, provides a press towards the skin around the throat, a better tightening at the tightening collar being provided.

9. A headset according claim 1, wherein the throat microphone is fixed to the skin against the throat by aid of a tape or a connected rubber strip or by a connected strip, intended to be tied around any body part.
